(19) United States
(12) Patent Application Publication
(10) Pub. No.: US 2015/0270590 A1
(43) Pub. Date: Sep. 24, 2015

(54) BATTERY MODULE

(71) Applicant: SANYO ELECTRIC CO., LTD., Osaka (JP)

(72) Inventors: Oose Okutani, Hyogo (JP); Shinya Geshi, Osaka (JP); Masatoshi Nagayama, Osaka (JP)

(21) Appl. No.: 14/436,877

(22) PCT Filed: Oct. 29, 2013
(86) PCT No.: PCT/JP2013/006376

§ 371 Date: Apr. 18, 2015

(30) Foreign Application Priority Data
Oct. 31, 2012 (JP) 2012-241253

(51) Int. Cl. H01M 10/6561

(52) U.S. Cl. CPC H01M 10/6561

(57) ABSTRACT

Battery module includes a plurality of substantially columnar batteries, and a plurality of cases that store respective batteries and are disposed in parallel with each other. Cases are disposed so that a vent disposed in one case of two adjacent cases communicates with a vent disposed in other case. Thus, the route from another vent disposed in one case to another vent disposed in other case is formed as an airflow path passing through the vents communicating with each other between adjacent cases.

### TECHNICAL FIELD

The present invention relates to a battery module including a plurality of batteries.

### BACKGROUND ART

Generally, a battery generates heat during charge/discharge. In order to stably operate a battery module including a plurality of batteries, however, it is preferable to prevent excessive increase in the temperature of the batteries. Therefore, a mechanism of efficiently cooling the batteries has been required. For this purpose, Patent Literature 1 discloses a technology including a vent near an end of a cylindrical case of a storage-battery power supply device.

### CITATION LIST

### Patent Literature

PTL 1: Unexamined Japanese Patent Publication No. H10-106520

### SUMMARY OF THE INVENTION

In the storage-battery power supply device of Patent Literature 1, an airflow path is disposed in parallel with the axial direction of each storage battery. In this technology, each battery individually requires each airflow path of a refrigerant such as air. In this regard, the inventers have found potential for improvement of the cooling structure of the batteries.

The present invention addresses such problems. The purpose of the present invention is to provide a technology of more easily cooling a battery module.

An aspect of the present invention is a battery module. The battery module includes a plurality of substantially columnar batteries, and a plurality of cases that store respective batteries and are disposed in parallel with each other. The plurality of cases are disposed so that a vent disposed in one of two adjacent cases communicates with a vent disposed in the other. Thus, the route from another vent disposed in the one case to another vent disposed in the other case is formed as an airflow path passing through the vents communicating with each other between the adjacent cases.

Regarding this battery module, by making a refrigerant flow from one vent of the battery module to two or more batteries, the battery module can be cooled more easily. In other words, in the battery module, a plurality of batteries are interconnected via communicating airflow paths, and hence the plurality of batteries can be collectively, efficiently cooled.

In the present invention, the battery module can be cooled more easily.

### BRIEF DESCRIPTION OF DRAWINGS

FIG. 1 is a perspective view showing a battery module in accordance with an exemplary embodiment.

FIG. 2 is a schematic diagram of the cross section taken along line A-A of FIG. 1 of the battery module in accordance with the exemplary embodiment.

FIG. 3 is a perspective view showing a battery module in accordance with a modified example.

FIG. 4 is a schematic diagram of the cross section taken along line B-B of FIG. 3 of the battery module in accordance with the modified example.

### DESCRIPTION OF EMBODIMENT(S)

Hereinafter, the exemplary embodiment of the present invention will be described with reference to the accompanying drawings. In all drawings, similar elements are denoted with the same reference marks, and the descriptions of those elements are omitted appropriately.

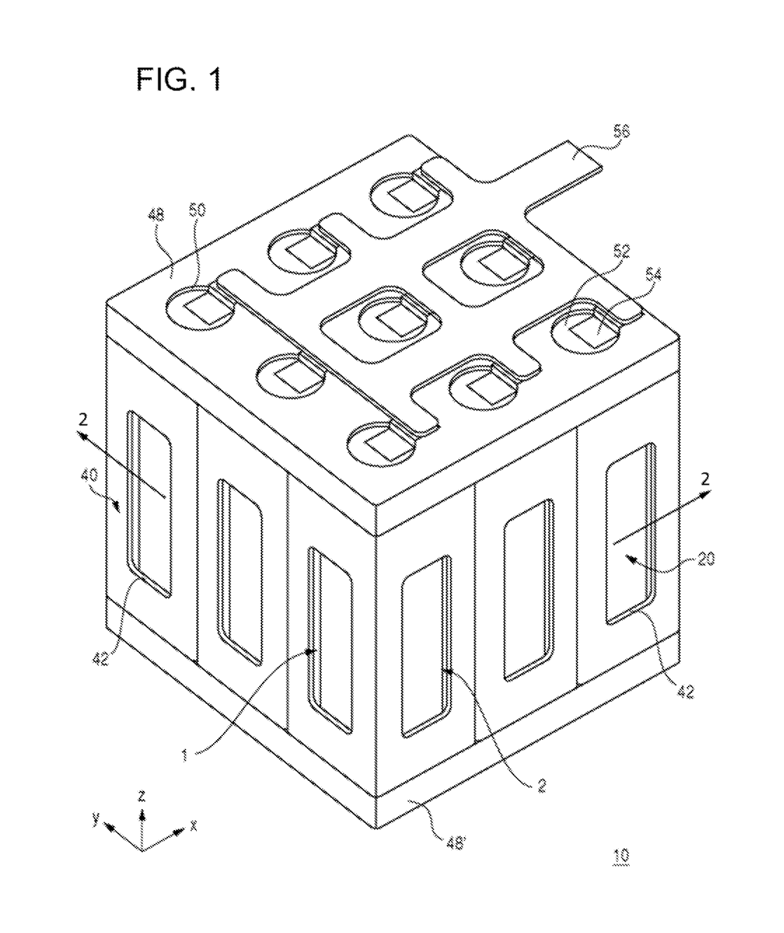

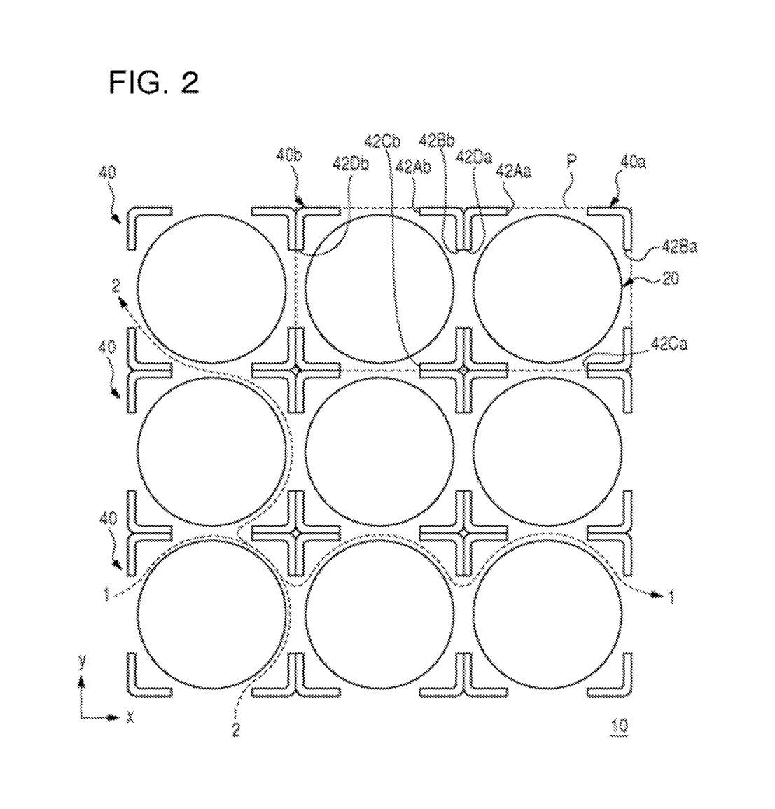

FIG. 1 is a perspective view showing a battery module in accordance with an exemplary embodiment. FIG. 2 is a schematic diagram of the cross section taken along line A-A of FIG. 1 of the battery module in accordance with the exemplary embodiment. In FIG. 2, the internal structure of battery 20 is omitted.

As shown in FIG. 1, battery module 10 includes a plurality of substantially columnar batteries 20, and a plurality of cases 40 that store respective batteries 20 and are disposed in parallel with each other. In the present exemplary embodiment, the outer shape of each battery 20 is a substantially columnar shape. However, the outer shape is not limited to this as long as airflow paths described later can be formed in battery module 10. The outer shape may be a rectangular shape, for example. Each battery 20 of the present exemplary embodiment is a lithium ion battery, but may be also applied to a nickel hydride battery or a nickel cadmium battery.

Each case 40 has a function of holding each battery 20 inside it and suppressing deformation of each battery 20 caused by heat generation. Each case 40 has a plurality of vents. Preferably, each case 40 has a substantially polygonal column shape.

In battery module 10 of the present exemplary embodiment, nine substantially cylindrical batteries 20 are stored in nine columnar cases 40 having a substantially square cross section, respectively. Each case 40 has four vents 42, and the vents in facing side surfaces of adjacent cases have substantially the same shape and size, and are located at substantially the same position. Cases 40 can be appropriately made of a metal having thermal conductivity, such as aluminum or magnesium, or an engineering plastic (resin) having insulation property, such as polypropylene (PP), polyethylene (PE), polybutylene terephthalate (PBT), or polyphenylene sulfide (PPS), for example. More preferably, as a thermal conductive material having insulation property—as a composite material—, the metal material that is coated with an insulating coating or the metal material that is integrated with the resin by outsert molding is employed. By using the thermal conductive material as cases 40, the heat of batteries 20 moves to cases 40, and hence the temperature of batteries 20 decreases. Thus, the cooling performance of batteries 20 can be improved.

In the state where the plurality of cases 40 are disposed in parallel with each other, lids 48 and 48′ each of which is formed integrally are overlaid on cases 40 at respective axial ends of batteries 20. Thus, the side surfaces of each battery 20 are in contact with the side surfaces of its adjacent batteries 20, respectively, and hence all batteries 20 are fixed integrally. Lid 48 has openings 50 so that a part of each negative electrode 52 disposed at an end of each battery 20 is exposed. Each negative electrode 52 is connected to bus bar 56 via each wire 54. Similarly, positive electrodes (not shown) are exposed from lid 48′, and positive electrodes are connected to a bus bar (not shown) via wires. In FIG. 1, nine batteries 20 are aligned in the same direction so that their negative electrodes face in the positive direction of z axis. Therefore, batteries 20 are interconnected in parallel. Lids 48 and 48′ can be appropriately made of a metal having thermal conductivity, such as aluminum or magnesium, or an engineering plastic (resin) having insulation property, such as polypropylene (PP), polyethylene (PE), polybutylene terephthalate (PBT), or polyphenylene sulfide (PPS), for example. More preferably, as a thermal conductive material having insulation property—as a composite material—, the metal material that is coated with an insulating coating or the metal material that is integrated with the resin by outsert molding is employed. By using the thermal conductive material as lids 48 and 48′, the heat of batteries 20 and cases 40 moves to lids 48 and 48′, and hence the temperature of batteries 20 can be further decreased. Thus, the cooling performance of batteries 20 can be further improved. When lids 48 and 48′ are made of the metal material, preferably, a plate having insulation property is disposed between each of lids 48 and 48′ and wire 54. Lids 48 and 48′ may be made of different materials.

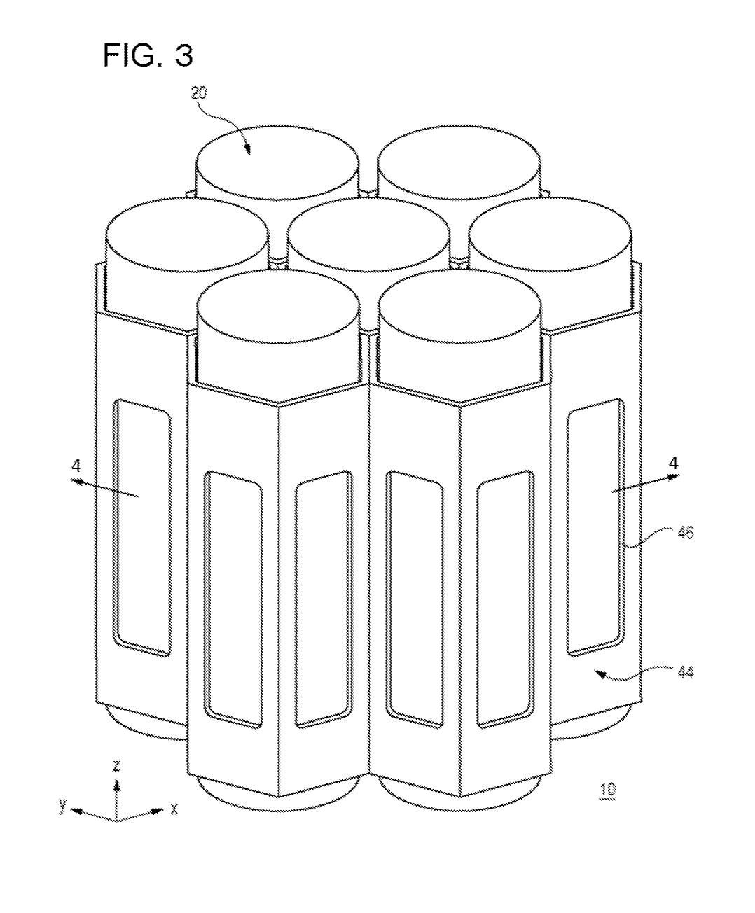

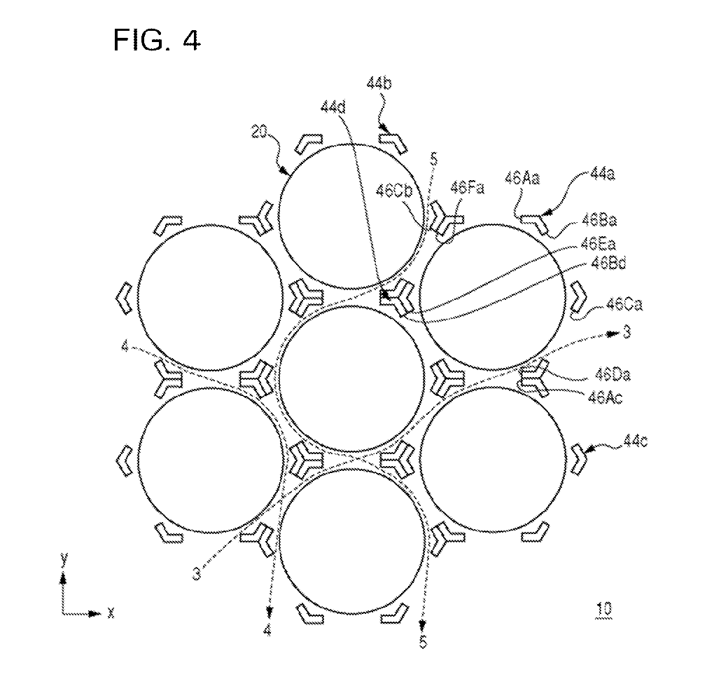

To stabilize the structure of battery module 10, preferably, each case 40 has a columnar shape having a substantially square cross section as in the present exemplary embodiment. Alternatively, each case 40 has a columnar shape having a substantially regular-polygonal cross section such as a substantially regular-hexagonal or substantially regular-triangular cross section, as described later using FIG. 3 and FIG. 4. In this case, from the viewpoint of the forming of the airflow paths and the productivity, it is particularly preferable that the plurality of cases 40 have substantially the same columnar shape and each vent is disposed at substantially the same position in each side surface. However, columnar cases 40 having another polygonal cross section may be also employed appropriately.

In battery module 10 of the present exemplary embodiment, as shown in region P of FIG. 2, the following relationship is established between two cases 40a and 40b. Two cases 40a and 40b are adjacent to each other, case 40a has vents 42Aa, 42Ba, 42Ca, and 42Da, and case 40b has vents 42Ab, 42Bb, 42Cb, and 42Db. Cases 40a and 40b are disposed so that vent 42Da disposed in one case 40a communicates with vent 42Bb disposed in other case 40b. Thus, the route from at least one of other vents 42Aa, 42Ba, and 42Ca disposed in one case 40a to at least one of other vents 42Ab, 42Cb, and 42Db disposed in other case 40b is formed as an airflow path passing through vent 42Da and vent 42Bb that communicate with each other between adjacent cases 40a and 40b.

In this case, when adjacent cases 40a and 40b are in contact with each other, vent 42Da and vent 42Bb that communicate with each other between adjacent cases 40a and 40b are formed as an airflow path between cases 40a and 40b.

In whole battery module 10, vents 42 disposed in the side surfaces exposed to the outside of battery module 10 are set as inlets and outlets of a refrigerant, and various airflow paths passing on at least two batteries 20 are formed. FIG. 2 shows airflow path 1 and airflow path 2, as an example.

As shown in FIG. 2, by forming vents 42 so that they have some width in the direction substantially perpendicular to the axial direction of batteries 20, clearances are formed between each battery 20 and side surfaces of each case 40. Thus, vents 42 have a structure through which a refrigerant easily passes. Each battery 20 is internally in contact with at least a part of the side surface of each case 40 that has vent 42. In other words, in each side surface of each case 40, a portion having vent 42 forms an airflow path as shown in FIG. 2, and, in a portion having no vent 42, each battery 20 is internally in contact with each case 40.

In above-mentioned battery module 10, by making a refrigerant flow from one vent 42 of battery module 10 to two or more batteries 20, battery module 10 can be cooled more easily. In other words, in battery module 10, a plurality of batteries 20 are interconnected via communicating airflow paths, so that the plurality of batteries 20 can be collectively, efficiently cooled.

By disposing vent 42 in a part in the axial direction of each side surface of each case 40, the cooling performance of batteries 20 and the fixing property of batteries 20 inside cases 40 can be kept. While, each vent 42 may be disposed in each side surface of each case 40 so as to have substantially the same length as the axial length of each battery 20. In this case, preferably, a fixing unit along a direction (xy plane direction) perpendicular to the axis of each battery 20 is further disposed on each of lids 48 and 48′, for example. Thus, the cooling performance of batteries 20 can be further improved while the fixing property of batteries 20 is kept.

The present exemplary embodiment has shown the structure where respective side surfaces of adjacent cases 40 are in contact with each other. However, the structure where respective side surfaces of adjacent cases 40 are not in contact with each other may be employed. In this case, the vents disposed in respective side surfaces may have a pipe shape, and may communicate with each other.

Cases 40 disposed on each outer surface of battery module 10 do not need to have vents in all of the side surfaces forming the outer surface. At least two vents, as an inlet and outlet of a refrigerant, are solely required in whole battery module 10. However, when many vents 42 are formed in cases 40 disposed on each outer surface of battery module 10 as shown in FIG. 2, inflow and outflow of a refrigerant occur through various positions. Therefore, each battery 20 can be efficiently cooled.

A battery system may be formed of one or more battery modules 10 and a cooling device (not shown). The cooling device cools each battery 20 by making a refrigerant flow through each airflow path. As the refrigerant, air can be used appropriately.

Inside each case 40, a partition for an airflow path that is in contact with each case 40 and each battery 20 may be disposed on a diagonal line of each case 40. Thus, a desired airflow path is formed, and battery 20 disposed at a position difficult to be cooled can be efficiently cooled.

### Modified Example

FIG. 3 is a perspective view showing a battery module in accordance with a modified example. FIG. 4 is a schematic diagram of the cross section taken along line B-B of FIG. 3 of the battery module in accordance with the modified example. In FIG. 3, bus bar 56 and lids 48 and 48′ are omitted. In FIG. 4, the internal structure of each battery 20 is omitted.

The modified example differs from the exemplary embodiment in that each battery 20 is stored in each case 44 having a substantially regular-hexagonal column shape. A vent is disposed in each side surface of each case 40. In the modified example, vents in respective side surfaces are denoted with 46A, 46B, 46C, 46D, 46E, and 46F clockwise sequentially from the vent substantially parallel with the x axis. Vents 46A, 46B, 46C, 46D, 46E, and 46F are formed so that the vents in adjacent side surfaces have substantially the same shape and size, and are located at substantially the same position.

In battery module 10, a plurality of cases 40 are most closely disposed in parallel while side surfaces of respective cases are in contact with each other. In this case, seven cases 44 are disposed in parallel. For example, among three cases 44b, 44c, and 44d adjacent to case 44a, vent 46Fa communicates with vent 46Cb, vent 46Da communicates with vent 46Ac, and vent 46Ea communicates with vent 46Bd. As a result, a path allowing a refrigerant to flow from one vent to at least two batteries 20 is formed inside battery module 10. FIG. 4 shows airflow path 3, airflow path 4, and airflow path 5 as an example.

Also in the modified example, an advantage similar to that of the above-mentioned exemplary embodiment is produced. Furthermore, the dead space can be reduced, and the number of batteries 20 used per unit volume can be increased.

The present invention is not limited to the above-mentioned exemplary embodiment. Modifications such as various design changes can be added to the exemplary embodiment on the basis of the knowledge of the persons skilled in the art. An exemplary embodiment having undergone such modifications is also included in the scope of the present invention.

The invention related to the above-mentioned exemplary embodiment may be specified with the following items.

### Item 1

A battery module includes a plurality of substantially columnar batteries, and a plurality of cases that store respective batteries and are disposed in parallel with each other. The plurality of cases are disposed so that a vent disposed in one of two adjacent cases communicates with a vent disposed in the other. Thus, the route from another vent disposed in the one case to another vent disposed in the other case is formed as an airflow path passing through the vents communicating with each other between the adjacent cases.

### Item 2

The battery module according to item 1 in which each of the plurality of cases has substantially the same columnar shape having a substantially regular-polygonal cross section, and each of the vents is disposed at substantially the same position in each side surface of each of the plurality of cases.

### Item 3

The battery module according to item 2 in which, by disposing the adjacent cases in contact with each other, the vents communicating with each other between the adjacent cases are formed as an airflow path between the adjacent cases.

### Item 4

The battery module according to one of items 1 to 3 in which each of the batteries is internally in contact with at least a part of the side surface of each of the plurality of cases that has each vent.

### REFERENCE MARKS IN THE DRAWINGS

10 battery module
20 battery
40, 44 case
42, 46 vent

1. A battery module comprising:
a plurality of substantially columnar batteries; and
a plurality of cases disposed in parallel with each other, each of the cases storing each of the batteries,
wherein, by disposing the plurality of cases so that a vent disposed in a first case of two adjacent cases communicates with a vent disposed in a second case, a route from another vent disposed in the first case to another vent disposed in the second case is formed as an airflow path passing through the vents communicating with each other between the adjacent cases.

2. The battery module according to claim 1, wherein
each of the plurality of cases has substantially the same columnar shape having a substantially regular-polygonal cross section, and each of the vents is disposed at substantially the same position in each side surface of each of the plurality of cases.

3. The battery module according to claim 2, wherein
by disposing the adjacent cases in contact with each other, the vents communicating with each other between the adjacent cases are formed as an airflow path between the adjacent cases.

4. The battery module according to claim 1, wherein
each of the plurality of batteries is internally in contact with at least a part of a side surface of each of the plurality of cases, the side surface having each of the vents.
